(19) United States
(12) Patent Application Publication
(10) Pub. No.: US 2017/0092002 A1
(43) Pub. Date: Mar. 30, 2017

(54) USER INTERFACE FOR AUGMENTED REALITY SYSTEM

(71) Applicants: Brian Mullins, Sierra Madre, CA (US); Matthew Kammerait, West Hollywood, CA (US); Michael French, Los Angeles, CA (US); Ian Crombie, Los Angeles, CA (US)

(72) Inventors: Brian Mullins, Sierra Madre, CA (US); Matthew Kammerait, West Hollywood, CA (US); Michael French, Los Angeles, CA (US); Ian Crombie, Los Angeles, CA (US)

(73) Assignee: DAQRI, LLC, Los Angeles, CA (US)

(21) Appl. No.: 14/870,799

(22) Filed: Sep. 30, 2015

(51) Int. Cl. G06T 19/00; G06F 3/0481; G02B 27/01; G06F 3/01

(52) U.S. Cl. CPC G06T 19/006; G06F 3/013; G06F 3/04817; G02B 27/0172; G02B 27/0179; G02B 2027/014; G02B 2027/0187

(57) ABSTRACT

A head-mounted device (HMD) includes sensors, a transparent display, a processor comprising an augmented reality (AR) application and an AR user interface module. The AR application generates virtual content based on sensing data from the sensors, and displays the virtual content in the transparent display. The AR user interface module generates an AR user interface that is positioned outside a field of view of a user based on the HMD being oriented at a reference pitch angle, causes a display of the AR user interface in the transparent display within the field of view of the user based on the HMD being oriented at a second pitch angle greater than the reference pitch angle, and causes a navigation of the AR user interface in response to a motion of the HMD and an eye gaze of the user matching a user interface trigger pattern.

### BACKGROUND

The subject matter disclosed herein generally relates to a user interface for an augmented reality device. Specifically, the present disclosure addresses systems and methods for displaying and operating a user interface in a transparent display of a head-mounted device.

User interfaces on mobile devices with touchscreen often use tapping, or swiping to activate features in applications. Some applications on mobile devices typically require the user to interact with the touchscreen with the user's fingers or stylus to provide input to the applications. Touchscreen inputs are impractical for head-mounted devices.

Furthermore, displaying a persistent user interface such as a menu in a transparent display of a head-mounted device can obstruct and block a view of real world objects behind the transparent display. Furthermore, the user interface persistently displayed in the transparent display can interfere with a view of the user operating the head-mounted device. Given the lack of screen real estate in the transparent display, a need exists for a user interface that is minimally invasive to the limited screen real estate in the transparent display, and that does not interfere with a view of the real-world objects.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 is a block diagram illustrating an example of a network environment suitable for an augmented reality user interface, according to some example embodiments.

FIG. 2 is a block diagram illustrating an example embodiment of modules (e.g., components) of a head-mounted device.

FIG. 3 is a block diagram illustrating an example embodiment of an augmented reality user interface module.

FIG. 4 is a block diagram illustrating an example embodiment of a navigation module.

FIG. 5 is diagram illustrating an example embodiment of an augmented reality user interface.

FIG. 6 is a block diagram illustrating a first example embodiment of an operation of an augmented reality user interface displayed in a head-mounted device at a reference pitch angle.

FIG. 7 is a block diagram illustrating a first example embodiment of an operation of an augmented reality user interface displayed in a head-mounted device at a second pitch angle.

FIG. 8 is a block diagram illustrating a first example embodiment of an operation of an augmented reality user interface displayed in a head-mounted device at a reference pitch angle.

FIG. 9 is a block diagram illustrating a second example embodiment of an operation of an augmented reality user interface displayed in a head-mounted device at a reference pitch angle.

FIG. 10 is a block diagram illustrating a second example embodiment of an operation of an augmented reality user interface displayed in a head-mounted device at a second pitch angle.

FIG. 11 is a block diagram illustrating a second example embodiment of an operation of an augmented reality user interface displayed in a head-mounted device at a reference pitch angle.

FIG. 12 is a block diagram illustrating an example embodiment of a horizontal angular margin for an eye gaze pattern of a head-mounted device at a reference pitch angle.

FIG. 13 is a block diagram illustrating an example embodiment of a horizontal angular margin for an eye gaze pattern of a head-mounted device at a second pitch angle.

FIG. 14 is a block diagram illustrating an example embodiment of an operation of an augmented reality user interface as shown a display of a head-mounted device at a reference second pitch angle.

FIG. 15 is a flowchart illustrating an example operation of enabling a augmented reality user interface.

FIG. 16 is a flowchart illustrating an example operation of using an augmented reality user interface.

FIG. 17 is a flowchart illustrating an example of operation of activating an augmented reality user interface.

FIG. 18 is a flowchart illustrating an example operation of navigating an augmented reality user interface.

FIG. 19 is a flowchart illustrating an example operation of selecting an icon of an augmented reality user interface.

FIG. 20 a block diagram illustrating components of a machine, according to some example embodiments, able to read instructions from a machine-readable medium and perform any one or more of the methodologies discussed herein.

### DETAILED DESCRIPTION

Example methods and systems are directed to a user interface for augmented reality (AR) systems. Examples merely typify possible variations. Unless explicitly stated otherwise, structures (e.g., structural components, such as modules) are optional and may be combined or subdivided, and operations (e.g., in a procedure, algorithm, or other function) may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

AR applications allow a user to experience information, such as in the form of a virtual object (e.g., a three-dimensional model of a virtual dinosaur) overlaid on an image of a real-world physical object (e.g., a billboard) captured by a camera of a viewing device. The viewing device may include a handheld device such as a tablet or smartphone, or a wearable device such as a head-mounted device (HMD) (e.g., helmet, glasses). The virtual object may be displayed in a transparent or clear display (e.g., see-through display) of the viewing device. The physical object may include a visual reference (e.g., uniquely identifiable pattern on a physical object) that the AR application can recognize. A visualization of the additional information, such as the virtual object overlaid or engaged with an image of the physical object, is generated in the display of the viewing device. The viewing device generates the virtual object based on the recognized visual reference (e.g., QR code) or captured image of the physical object (e.g., image of a logo). The viewing device displays the virtual object based on a relative position between the viewing device and the visual reference. For example, a virtual dinosaur appears closer and bigger when the viewing device is held closer to the visual reference associated with the virtual dinosaur. Similarly, the virtual dinosaur appears smaller and farther away when the viewing device is moved further away from the virtual reference associated with the virtual dinosaur. The virtual object may include a three-dimensional model of a virtual object or a two-dimensional model of a virtual object. For example, the three-dimensional model includes a three-dimensional view of a chair. The two-dimensional model includes a two-dimensional view of a dialog box, menu, or written information such as statistics information for a baseball player. The viewing device renders an image of the three-dimensional or two-dimensional model of the virtual object in the display of the viewing device.

Persistent user interfaces such as a menu permanently displayed in the transparent display of a head-mounted device can obstruct and block the user of the head-mounted device. Such persistent user interface can thus interfere with the user trying to operate visible physical tools in the line of sight of the user. Given the lack of screen real estate in a transparent display, the present application describes an augmented reality user interface that is minimally invasive to the limited screen real estate in the transparent display, and that does not interfere with the user's line of sight when operating physical objects.

The HMD generates an augmented reality user interface that is displayed in the transparent display of the HMD based on an orientation, a position, a movement of the HMD (e.g., the speed at which the HMD rotates), an eye gaze of the user, and whether virtual content is displayed in the transparent display when the HMD is positioned in a normal viewing position (e.g., a user wearing the HMD looking straight) as measured by a pitch angle of the HMD. In a normal viewing position, the HMD is level to a horizontal plane, and the pitch angle of the HMD is about 0 degrees.

In one example embodiment, the augmented reality (AR) user interface may be displayed in the shape of a virtual crown or carousel hovering above the head of the user of the HMD. For example, the AR user interface is positioned outside the vertical field of view of the user when the HMD is at a reference pitch angle (e.g., 0 degrees pitch angle—or the user is looking straight as opposed to up or down). The vertical field of view of the user at the reference pitch angle may be, for example, about 30 degrees tall. Therefore, the user cannot see the AR user interface when the user is wearing the HMD at the reference pitch angle since the AR user interface is positioned outside the vertical field of view of the user (e.g., above the field of view of the user when the user is looking straight).

When the user tilts his/her head up, the AR user interface appears in the transparent display. For example, as the user tilts his/her head up, the pitch angle of the HMD increases, and a greater portion of the AR user interface is displayed in the transparent display. In one example, the entire AR user interface progressively appears in the transparent display when the pitch angle increases. In another example, the entire AR user interface is displayed only when the pitch angle exceeds a preset angle.

The orientation, position, and the speed of movement of the HMD is monitored to determine and differentiate whether the user intentionally requested to access the AR user interface when looking up. For a first scenario, the user may be just looking up to see the top of a building. In a second scenario, the user looks up to access the AR user interface. To distinguish the two scenarios, the HMD determines a pattern of the eye gaze (e.g., the user looks around and up as opposed to straight up), a speed at which the HMD rotates (the pitch angle increases at a steady pace as opposed to irregular pace), a presence of any virtual content in the transparent display when the user is looking straight or when the pitch angle of the HMD is about zero degrees (e.g., reference or default pitch angle). In a third scenario, the AR application 210 can display the AR user interface independent of the pitch angle of the HMD.

The HMD generates an adaptive sweet spot based on the eye gaze pattern, the HMD rotation pattern, and the presence of virtual content in the transparent display at a reference pitch angle. For example, the adaptive sweet spot may include a virtual band having a threshold as an angular margin in the transparent display. For example, if no virtual content is displayed in the transparent display at the reference pitch angle, the adaptive sweet spot includes a wider angular margin. If a virtual content is displayed in the transparent display at the reference pitch angle, the adaptive sweet spot includes a narrower angular margin. Therefore, the user can engage the AR user interface by looking perfectly straight up and down when virtual content is present in the transparent display. In one example embodiment, the AR user interface remains in its virtual position when the user is looking up and engaging with the AR user interface. In another example, the AR user interface drops down to allow the user to engage with the AR user interface at a horizontal viewing level (e.g., zero degrees pitch angle).

The user can navigate the AR user interface by turning his/her head left or right to rotate the virtual carousel. The speed of rotation of the virtual carousel may depend on the speed at which the user is turning his head and how far the user is turning his head. The speed of rotation may be set based on user preferences or dynamically on other values by the AR application 210. The user can select a particular icon or command in the virtual carousel to stare at the particular icon for a predefined minimum duration. The icon may progressively change appearance (e.g., shape or color) as the user stares at an icon in the virtual carousel. The user can disengage the AR user interface by looking away or turning his/her away.

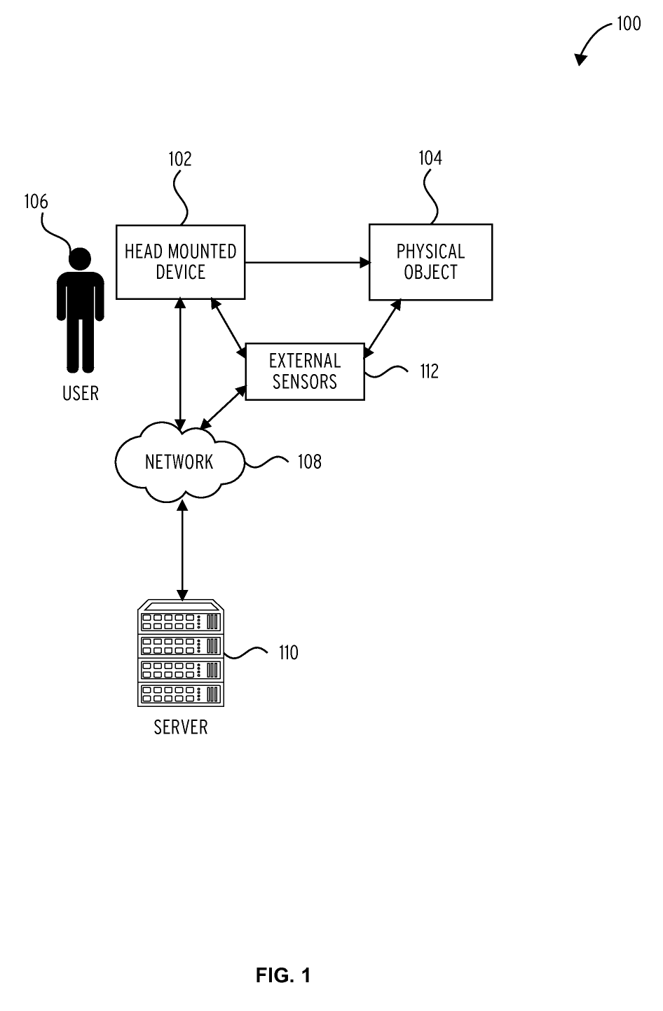

FIG. 1 is a block diagram illustrating an example of a network environment suitable for an augmented reality user interface, according to some example embodiments.

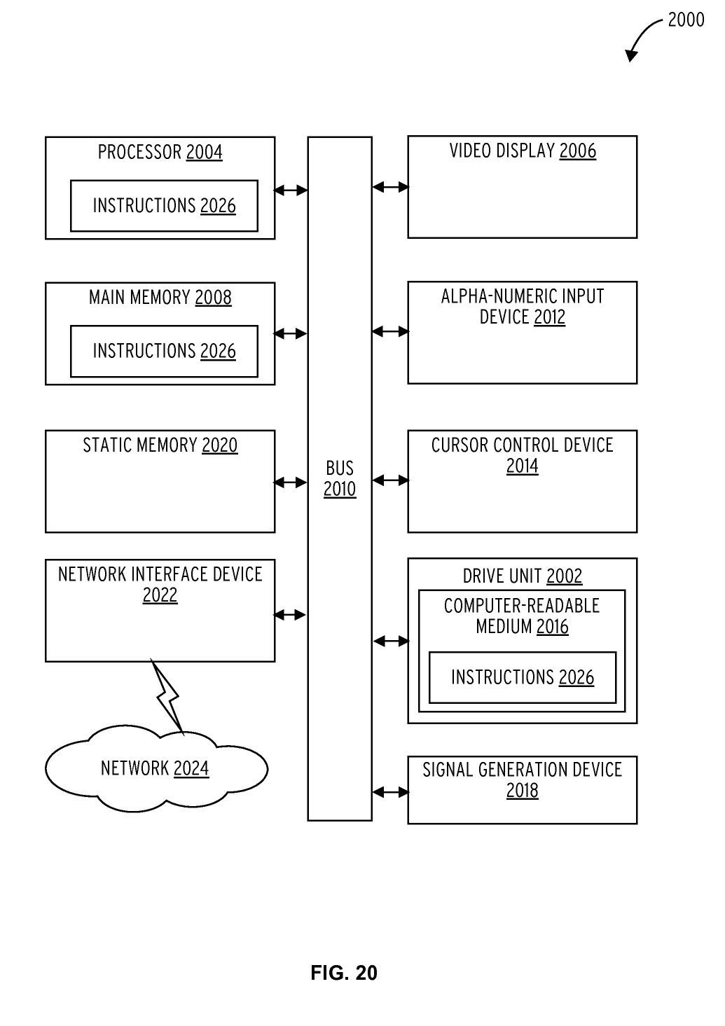

A network environment 100 includes a head-mounted device 102 and a server 110, communicatively coupled to each other via a network 108. The head-mounted device 102 and the server 110 may each be implemented in a computer system, in whole or in part, as described below with respect to FIG. 20.

The server 110 may be part of a network-based system. For example, the network-based system may be or include a cloud-based server system that provides additional information, such as 3D models or other virtual objects, to the head-mounted device 102.

A user 106 may wear the head-mounted device 102 and look at a physical object 104 in a real-world physical environment. The user 106 may be a human user (e.g., a human being), a machine user (e.g., a computer configured by a software program to interact with the head-mounted device 102), or any suitable combination thereof (e.g., a human assisted by a machine or a machine supervised by a human). The user 106 is not part of the network environment 100, but is associated with the head-mounted device 102. For example, the head-mounted device 102 may be a computing device with a camera and a transparent display such as a tablet, smartphone, or a wearable computing device (e.g., helmet or glasses). In another example embodiment, the computing device may be hand held or may be removably mounted to the head of the user 106. In one example, the display may be a screen that displays what is captured with a camera of the head-mounted device 102. In another example, the display of the head-mounted device 102 may be transparent or semi-transparent such as in lenses of wearable computing glasses or the visor or a face shield of a helmet.

The user 106 may be a user of an AR application in the head-mounted device 102 and at the server 110. The AR application may provide the user 106 with an AR experience triggered by identified objects (e.g., physical object 104) in the physical environment. For example, the physical object 104 may include identifiable objects such as a 2D physical object (e.g., a picture), a 3D physical object (e.g., a factory machine), a location (e.g., at the bottom floor of a factory), or any references (e.g., perceived corners of walls or furniture) in the real-world physical environment. The AR application may include computer vision recognition to determine corners, objects, lines, letters, etc.

In one example embodiment, the objects in the image are tracked and recognized locally in the head-mounted device 102 using a local context recognition dataset or any other previously stored dataset of the AR application of the head-mounted device 102. The local context recognition dataset module may include a library of virtual objects associated with real-world physical objects or references. In one example, the head-mounted device 102 identifies feature points in an image of the physical object 104. The head-mounted device 102 may also identify tracking data related to the physical object 104 (e.g., GPS location of the head-mounted device 102, orientation, distance to the physical object 104). If the captured image is not recognized locally at the head-mounted device 102, the head-mounted device 102 can download additional information (e.g., 3D model or other augmented data) corresponding to the captured image, from a database of the server 110 over the network 108.

In another example embodiment, the physical object 104 in the image is tracked and recognized remotely at the server 110 using a remote context recognition dataset or any other previously stored dataset of an AR application in the server 110. The remote context recognition dataset module may include a library of virtual objects or augmented information associated with real-world physical objects or references.

External sensors 112 may be associated with, coupled to, related to the physical object 104 to measure a location, status, and characteristics of the physical object 104. Examples of measured readings may include but are not limited to weight, pressure, temperature, velocity, direction, position, intrinsic and extrinsic properties, acceleration, and dimensions. For example, external sensors 112 may be disposed throughout a factory floor to measure movement, pressure, orientation, and temperature. The external sensors 112 can also be used to measure a location, status, and characteristics of the head-mounted device 102 and the user 106. The server 110 can compute readings from data generated by the external sensors 112. The server 110 can generate virtual indicators such as vectors or colors based on data from external sensors 112. Virtual indicators are then overlaid on top of a live image or a view of the physical object 104 in a line of sight of the user 106 to show data related to the physical object 104. For example, the virtual indicators may include arrows with shapes and colors that change based on real-time data. The visualization may be provided to the physical object 104 so that the head-mounted device 102 can render the virtual indicators in a display of the head-mounted device 102. In another example embodiment, the virtual indicators are rendered at the server 110 and streamed to the head-mounted device 102.

The external sensors 112 may include other sensors used to track the location, movement, and orientation of the head-mounted device 102 externally without having to rely on sensors internal to the head-mounted device 102. The sensors 112 may include optical sensors (e.g., depth-enabled 3D camera), wireless sensors (Bluetooth, Wi-Fi), GPS sensors, and audio sensors to determine the location of the user 106 wearing the head-mounted device 102, distance of the user 106 to the external sensors 112 (e.g., sensors placed in corners of a venue or a room), the orientation of the head-mounted device 102 to track what the user 106 is looking at (e.g., direction at which the head-mounted device 102 is pointed, e.g., head-mounted device 102 pointed towards a player on a tennis court, head-mounted device 102 pointed at a person in a room).

In another example embodiment, data from the external sensors 112 and internal sensors in the head-mounted device 102 may be used for analytics data processing at the server 110 (or another server) for analysis on usage and how the user 106 is interacting with the physical object 104 in the physical environment. Live data from other servers may also be used in the analytics data processing. For example, the analytics data may track at what locations (e.g., points or features) on the physical or virtual object the user 106 has looked, how long the user 106 has looked at each location on the physical or virtual object, how the user 106 wore the head-mounted device 102 when looking at the physical or virtual object, which features of the virtual object the user 106 interacted with (e.g., such as whether the user 106 engaged with the virtual object), and any suitable combination thereof. The head-mounted device 102 receives a visualization content dataset related to the analytics data. The head-mounted device 102 then generates a virtual object with additional or visualization features, or a new experience, based on the visualization content dataset.

Any of the machines, databases, or devices shown in FIG. 1 may be implemented in a general-purpose computer modified (e.g., configured or programmed) by software to be a special-purpose computer to perform one or more of the functions described herein for that machine, database, or device. For example, a computer system able to implement any one or more of the methodologies described herein is discussed below with respect to FIG. 20. As used herein, a “database” is a data storage resource and may store data structured as a text file, a table, a spreadsheet, a relational database (e.g., an object-relational database), a triple store, a hierarchical data store, or any suitable combination thereof. Moreover, any two or more of the machines, databases, or devices illustrated in FIG. 1 may be combined into a single machine, and the functions described herein for any single machine, database, or device may be subdivided among multiple machines, databases, or devices.

The network 108 may be any network that enables communication between or among machines (e.g., server 110), databases, and devices (e.g., head-mounted device 102). Accordingly, the network 108 may be a wired network, a wireless network (e.g., a mobile or cellular network), or any suitable combination thereof. The network 108 may include one or more portions that constitute a private network, a public network (e.g., the Internet), or any suitable combination thereof

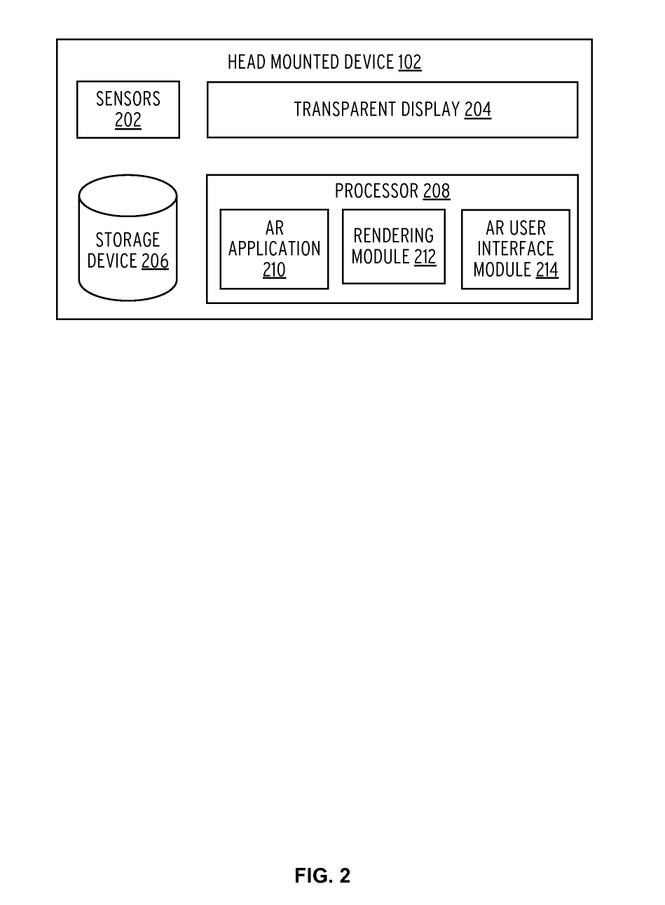

FIG. 2 is a block diagram illustrating an example embodiment of modules (e.g., components) of a head-mounted device.

The head-mounted device 102 includes sensors 202, a transparent display 204, a processor 208, and a storage device 206. For example, the head-mounted device 102 may include a helmet, a visor, or any other device mounted to the head of the user 106.

The sensors 202 include, for example, a thermometer, an infrared camera, a barometer, a humidity sensor, an EEG sensor, a proximity or location sensor (e.g., near field communication, GPS, Bluetooth, Wi-Fi), an optical sensor (e.g., camera), an orientation sensor (e.g., gyroscope), an audio sensor (e.g., a microphone), or any suitable combination thereof. For example, the sensors 202 may include a rear-facing camera and a front-facing camera in the head-mounted device 102. It is noted that the sensors described herein are for illustration purposes and the sensors 202 are thus not limited to the ones described.

The transparent display 204 includes, for example, a display configured to display images generated by the processor 208. In another example, the transparent display 204 includes a touch-sensitive surface to receive a user input via a contact on the touch-sensitive surface.

The processor 208 includes an AR application 210, a rendering module 212, and an AR user interface module 214. The AR application 210 receives data from sensors 202 (e.g., receives an image of the physical object 104) and identifies and recognizes the physical object 104 using machine-vision recognition techniques. The AR application 210 then retrieves from the storage device 206 AR content associated with the physical object 104. In one example embodiment, the AR application 210 identifies a visual reference (e.g., a logo or QR code) on the physical object 104 (e.g., a chair) and tracks the location of the visual reference within the transparent display 204 of the head-mounted device 102. The visual reference may also be referred to as a marker and may consist of an identifiable image, symbol, letter, number, machine-readable code. For example, the visual reference may include a bar code, a quick response (QR) code, or an image that has been previously associated with the virtual object.

The rendering module 212 renders virtual objects based on data from sensors 202. For example, the rendering module 212 renders a display of a virtual object (e.g., a door with a color based on the temperature inside the room as detected by sensors from HMDs inside the room) based on a three-dimensional model of the virtual object (e.g., 3D model of a virtual door) associated with the physical object 104 (e.g., a physical door). In another example, the rendering module 212 generates a display of the virtual object overlaid on an image of the physical object 104 captured by a camera of the head-mounted device 102. The virtual object may be further manipulated (e.g., by the user 106) by moving the physical object 104 relative to the head-mounted device 102. Similarly, the display of the virtual object may be manipulated (e.g., by the user 106) by moving the head-mounted device 102 relative to the physical object 104.

In another example embodiment, the rendering module 212 includes a local rendering engine that generates a visualization of a three-dimensional virtual object overlaid on (e.g., superimposed upon, or otherwise displayed in tandem with) an image of the physical object 104 captured by a camera of the head-mounted device 102 or a view of the physical object 104 in the transparent display 204 of the head-mounted device 102. A visualization of the three-dimensional virtual object may be manipulated by adjusting a position of the physical object 104 (e.g., its physical location, orientation, or both) relative to the camera of the head-mounted device 102. Similarly, the visualization of the three-dimensional virtual object may be manipulated by adjusting a position camera of the head-mounted device 102 relative to the physical object 104.

In one example embodiment, the rendering module 212 identifies the physical object 104 (e.g., a physical telephone) based on data from sensors 202 and external sensors 112, accesses virtual functions (e.g., increase or lower the volume of a nearby television) associated with physical manipulations (e.g., lifting a physical telephone handset) of the physical object 104, and generates a virtual function corresponding to a physical manipulation of the physical object 104.

In another example embodiment, the rendering module 212 determines whether the captured image matches an image locally stored in the storage device 206 that includes a local database of images and corresponding additional information (e.g., three-dimensional model and interactive features). The rendering module 212 retrieves a primary content dataset from the server 110, and generates and updates a contextual content dataset based on an image captured with the head-mounted device 102.

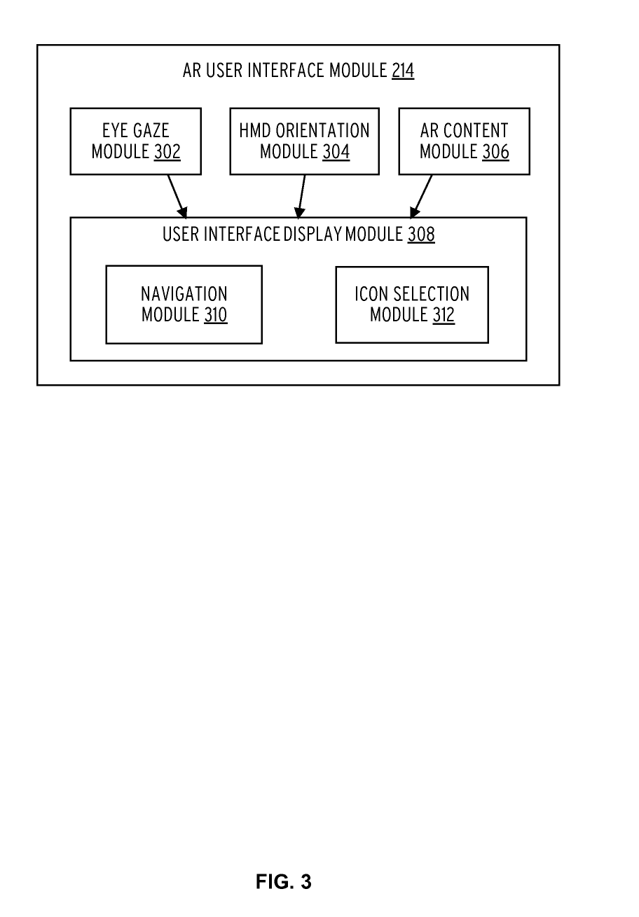

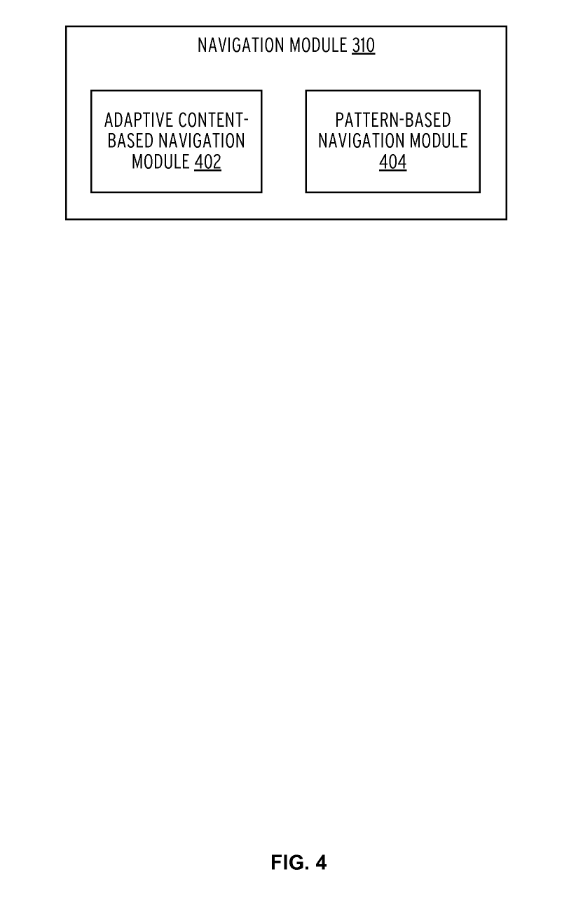

The AR user interface module 214 generates an AR user interface to be displayed in the transparent display 204. The AR user interface is accessible to the user 106 when the user 106 tilts his/her head up. The AR user interface may be represented and perceived by the user 106 as a virtual carousel or a crown hovering above the head of the user 106. The AR user interface module 214 determines whether the user 106 intentionally seeks to engage the AR user interface based on an eye gaze pattern of the user 106, a speed of a head movement of the user 106 and the head-mounted device 102, and whether virtual content is already present and displayed in the transparent display 204 while the user 106 is looking straight or the head-mounted device 102 is oriented parallel to a horizontal level (e.g., zero degree pitch angle). The components of the AR user interface module 214 are described in more detail with respect to FIG. 3 and FIG. 4 below.

The storage device 206 stores an identification of the sensors and their respective functions. The storage device 206 further includes a database of visual references (e.g., images, visual identifiers, features of images) and corresponding experiences (e.g., three-dimensional virtual objects, interactive features of the three-dimensional virtual objects). For example, the visual reference may include a machine-readable code or a previously identified image (e.g., a picture of shoe). The previously identified image of the shoe may correspond to a three-dimensional virtual model of the shoe that can be viewed from different angles by manipulating the position of the HMD 102 relative to the picture of the shoe. Features of the three-dimensional virtual shoe may include selectable icons on the three-dimensional virtual model of the shoe. An icon may be selected or activated using a user interface on the HMD 102.

In another example embodiment, the storage device 206 includes a primary content dataset, a contextual content dataset, and a visualization content dataset. The primary content dataset includes, for example, a first set of images and corresponding experiences (e.g., interaction with three-dimensional virtual object models). For example, an image may be associated with one or more virtual object models. The primary content dataset may include a core set of images of the most popular images determined by the server 110. The core set of images may include a limited number of images identified by the server 110. For example, the core set of images may include the images depicting covers of the ten most popular magazines and their corresponding experiences (e.g., virtual objects that represent the ten most popular magazines). In another example, the server 110 may generate the first set of images based on the most popular or often scanned images received at the server 110. Thus, the primary content dataset does not depend on objects or images scanned by the rendering module 212 of the HMD 102.

The contextual content dataset includes, for example, a second set of images and corresponding experiences (e.g., three-dimensional virtual object models) retrieved from the server 110. For example, images captured with the HMD 102 that are not recognized (e.g., by the server 110) in the primary content dataset are submitted to the server 110 for recognition. If the captured image is recognized by the server 110, a corresponding experience may be downloaded at the HMD 102 and stored in the contextual content dataset. Thus, the contextual content dataset relies on the context in which the HMD 102 has been used. As such, the contextual content dataset depends on objects or images scanned by the rendering module 212 of the HMD 102.

In one embodiment, the HMD 102 may communicate over the network 108 with the server 110 to retrieve a portion of a database of visual references, corresponding three-dimensional virtual objects, and corresponding interactive features of the three-dimensional virtual objects. The network 108 may be any network that enables communication between or among machines, databases, and devices (e.g., the HMD 102). Accordingly, the network 108 may be a wired network, a wireless network (e.g., a mobile or cellular network), or any suitable combination thereof. The network 108 may include one or more portions that constitute a private network, a public network (e.g., the Internet), or any suitable combination thereof

Any one or more of the modules described herein may be implemented using hardware (e.g., a processor of a machine) or a combination of hardware and software. For example, any module described herein may configure a processor to perform the operations described herein for that module. Moreover, any two or more of these modules may be combined into a single module, and the functions described herein for a single module may be subdivided among multiple modules. Furthermore, according to various example embodiments, modules described herein as being implemented within a single machine, database, or device may be distributed across multiple machines, databases, or devices.

FIG. 3 is a block diagram illustrating an example embodiment of an augmented reality user interface module. The AR user interface module 214 may include an eye gaze module 302, an HMD orientation module 304, an AR content module 306, and a user interface display module 308. The (optional) eye gaze module 302 tracks an eye gaze of the user 106. For example, the eye gaze module 302 uses a camera aimed at the eye of the user 106 to track a position and a movement of the pupil relative to the eye of the user 106 to determine the eye gaze of the user 106. The eye gaze module 302 can determine where in the transparent display 204 and for how long the user 106 has looked. For example, the eye gaze module 302 determines whether the user 106 looks upward or downward. The eye gaze module 302 tracks the eye gaze and generates an eye gaze pattern based on the movement of the pupil of the eyes of the user 106. Furthermore, the eye gaze module 302 can measure the speed at which the eyes of the user 106 move when the user 106 looks through the transparent display 204. For example, the eye gaze module 302 measures how fast the user 106 is looking upward or downward by measuring how fast the eyes of the user 106 move up or down.

The HMD orientation module 304 determines an orientation and position of the head-mounted device 102. The HMD orientation module 304 measures a vertical orientation of the head-mounted device 102. For example, the HMD orientation module 304 determines whether the user 106 is looking straight, up, or down by measuring a pitch angle of the head-mounted device 102 relative to a horizontal level. As the user 106 looks up, the pitch angle of the head-mounted device 102 increases. In another example, the pitch angle of the head-mounted device 102 becomes negative as the user 106 looks down below a horizontal level. The HMD orientation module 304 can further measure a horizontal relative orientation of the head-mounted device 102 to determine whether the user 106 is looking left or right by measuring an angular rotational acceleration using the sensors 202 of the head-mounted device 102. The HMD orientation module 304 can also measure an angular direction in which the head-mounted device 102 is rotated, a speed, and an acceleration of the rotational movement of the head-mounted device 102.

The AR content module 306 determines whether a virtual content is already displayed or present in the transparent display 204 while the head-mounted device 102 is oriented in a horizontal position (e.g., zero pitch angle) as determined by the HMD orientation module 304. For example, the physical object 104 may trigger a corresponding virtual content to be displayed in the transparent display 204 while the head-mounted device 102 is horizontally positioned and the user 106 is looking straight at the physical object 104. In that example, the AR content module 306 first determines whether the head-mounted device 102 is horizontally positioned (e.g., zero pitch angle), and if so, detects whether virtual content is being displayed in the transparent display 204.

The user interface display module 308 receives eye gaze tracking data from the eye gaze module 302, orientation data from the HMD orientation module 304, and virtual content presence data from the AR content module 306 to determine whether the user 106 intentionally seeks to access and engage an AR user interface to be displayed in the transparent display 204 and generated by the user interface display module 308. In a first example, the user interface display module 308 first determines whether virtual content is already being displayed in the transparent display 204 while the head-mounted device 102 is orientated in a reference pitch angle (e.g., zero degree pitch angle corresponding to a horizontal level). In another example embodiment, the reference pitch angle may include another pitch angle (e.g., 5 degrees) or a range of pitch angles (e.g., −5 to 5 degrees). The user interface display module 308 then generates a horizontal angular margin based on the presence of virtual content at the reference pitch angle. For example, the user interface display module 308 generates a first horizontal angular margin (e.g., a narrow horizontal angular band or threshold) when virtual content is present in the transparent display 204 at the reference pitch angle. The user interface display module 308 also generates a second horizontal angular margin (e.g., a wider horizontal angular band or threshold) when virtual content is present in the transparent display 204 at the reference pitch angle.

Once the user interface display module 308 determines the horizontal angular margin, the user interface display module 308 accesses the eye gaze tracking data from the eye gaze module 302 if available and the orientation data from the HMD orientation module 304 and determines whether the eye gaze pattern and orientation fits within the horizontal angular margin to determine that the user 106 intentionally seeks to engage the AR user interface. For example, the user interface display module 308 displays the AR user interface in the transparent display 204 if the user 106 has deliberately looked up within the first horizontal angular margin or the second horizontal angular margin. A narrower horizontal angular margin when AR content is already displayed in the transparent display 204 makes it harder for the user 106 to engage the AR user interface because the user 106 would have to look up straight and at a steady pace.

Once the user interface display module 308 determines that the eye gaze pattern matches the horizontal angular margins, the user interface display module 308 can display an increasing portion of the AR user interface as the pitch angle increases until the AR user interface is fully displayed in the transparent display 204. In another example embodiment, the user interface display module 308 displays the full AR user interface only when the pitch angle exceeds a minimum pitch angle threshold. In yet another example embodiment, the user interface display module 308 progressively displays the full AR user interface in the transparent display 204 from a faintly visible AR user interface to a fully visible AR user interface as the pitch angle increases.

In one example embodiment, the AR user interface remains visible in the transparent display 204 when the head-mounted device 102 is positioned at a minimum threshold pitch angle (e.g., while the user 106 is looking up). In another example embodiment, the AR user interface moves down to a field of view corresponding to the reference pitch angle (e.g., the AR user interface appears to move down, so the user 106 moves his/her head down to follow the AR user interface). The user 106 may navigate and engage with the AR user interface more conveniently while the AR user interface is displayed in the transparent display 204 and when the user 106 is looking straight.

The user interface display module 308 includes a navigation module 310 and an icon selection module 312. The navigation module 310 detects a head movement and an eye gaze movement to determine the direction and speed in which to navigate or rotate the AR user interface (e.g., virtual carousel). For example, the virtual carousel may rotate in a first direction when the user 106 turns his/her head to the left. The virtual carousel rotates in the opposite direction to the first direction when the user 106 turns his/her head to the right. In another example, the user interface display module 308 pans the AR user interface right in the transparent display 204 in response to the user 106 moving his/her head to the right. Similarly, the user interface display module 308 pans the AR user interface left in the transparent display 204 in response to the user 106 moving his/her head to the left.

The icon selection module 312 detects whether the user 106 seeks to access a command of an icon or component in the AR user interface. For example, the icon selection module 312 determines whether the user 106 has gazed or looked at a particular icon in the AR user interface for at least a minimum time threshold.

FIG. 4 is a block diagram illustrating an example embodiment of a navigation module.

The navigation module 310 enables the user 106 to navigate and interact with the AR user interface. The navigation module 310 includes an adaptive content-based navigation module 404, and a pattern-based navigation module 406. The adaptive content-based navigation module 404 determines whether virtual content is already displayed in the transparent display 204 at the reference pitch angle and enables the user 106 to navigate the AR user interface only when the eye gaze pattern and head movement of the user 106 match the activation pattern (e.g., first horizontal angular margin and second horizontal angular margin).

The pattern-based navigation module 406 determines which activation pattern is selected based on whether virtual content is already displayed in the transparent display 204 at the reference pitch angle of the head-mounted device 102. For example, the eye gaze pattern or head movement is to match the first horizontal angular margin if virtual content is already displayed in the transparent display 204 at the reference pitch angle. The eye gaze pattern or head movement is to match the second horizontal angular margin if virtual content is already displayed in the transparent display 204 at the reference pitch angle.

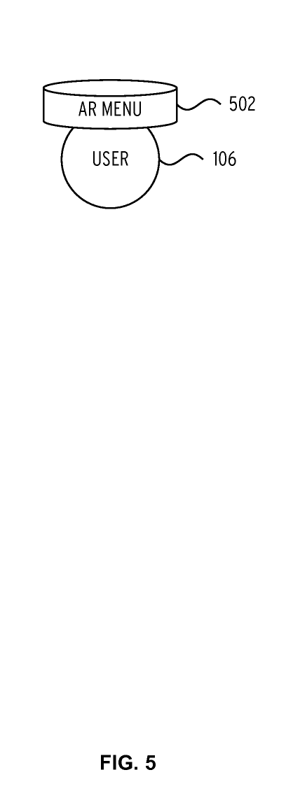

FIG. 5 is diagram illustrating an example embodiment of an augmented reality user interface.

The user 106 may perceive through the transparent display 204 an AR menu 502 hovering around the head of the user 106. The AR menu 502 may appear in the shape of a crown or carousel above the head of the user 106. The AR menu 502 may rotate to the left or right based on a movement or gesture of the head of the user 106. For example, the AR menu 502 may rotate left when the user 106 turns his/head to the left.

In another example, the AR menu 502 may initially appear as hovering above the head of the user 106 until it is determined that the user 106 seeks to engage and access the AR menu 502 by deliberately looking straight up. The AR menu 502 may move down to be displayed within a field of view of the user 106 when the user 106 is looking straight (at a reference pitch angle).

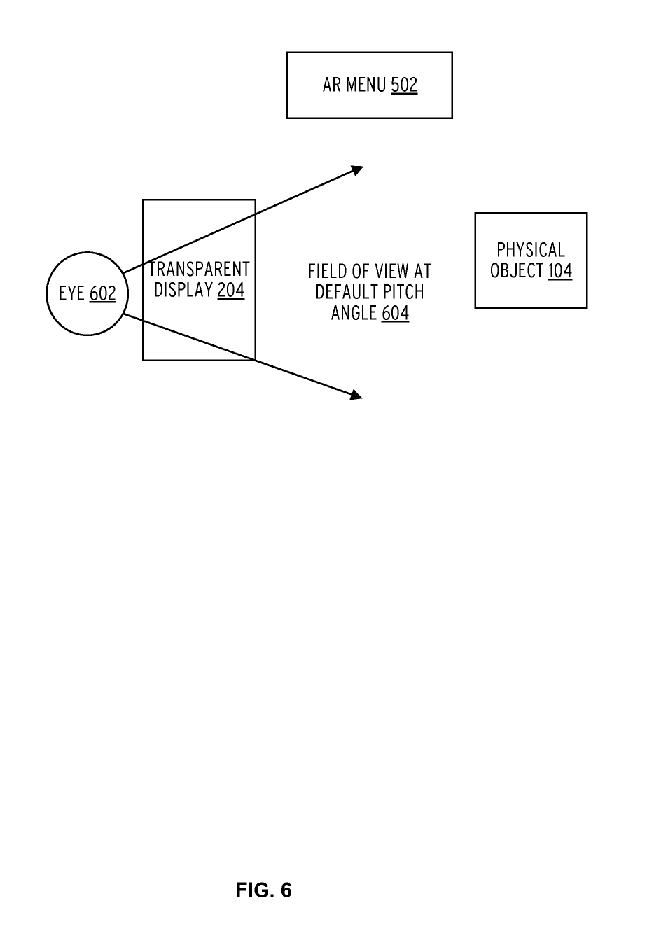

FIG. 6 is a block diagram illustrating a first example embodiment of an operation of an augmented reality user interface displayed in a head-mounted device at a reference pitch angle.

The transparent display 204 is positioned between an eye 602 of the user 106 and the physical object 104. The transparent display 204 does not display any virtual content within a field of view at reference pitch angle 604. The physical object 104 is positioned within the field of view at reference pitch angle 604. The AR menu 502 is positioned outside the field of view at reference pitch angle 604. Therefore, the user 106 cannot see the AR menu 502 when looking straight at the physical object 104. The user 106 would have to look up to see to the AR menu 502.

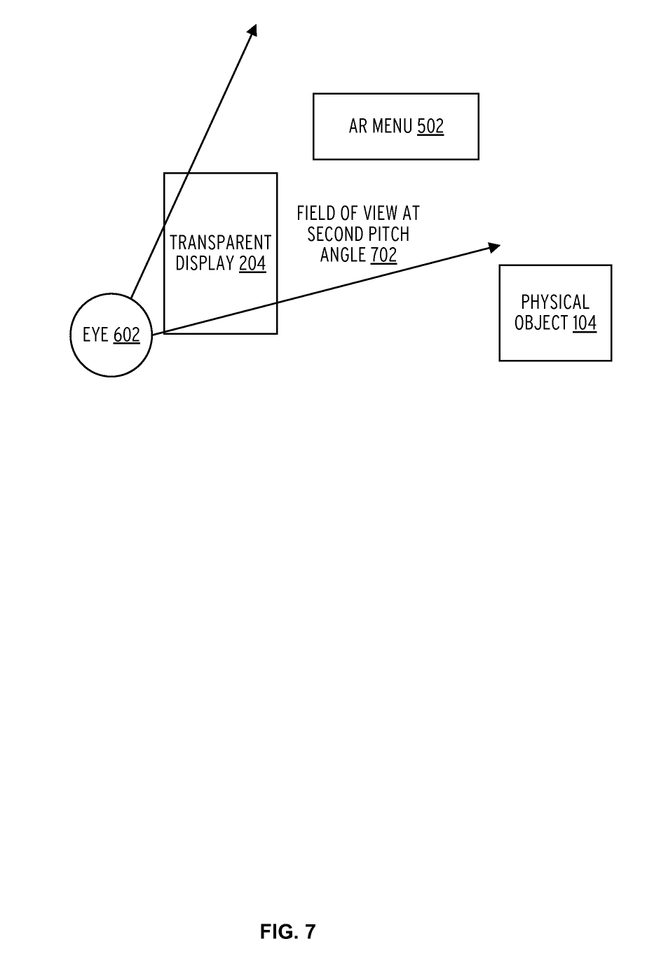

FIG. 7 is a block diagram illustrating a first example embodiment of an operation of an augmented reality user interface displayed in a head-mounted device at a second pitch angle.

When the user 106 looks up, the pitch angle of the head-mounted device 102 increases to a second pitch angle. The AR menu 502 is displayed in the transparent display 204 within a field of view at second pitch angle 702. In one example embodiment, the user 106 perceives the AR menu 502 as hovering above the head of the user 106.

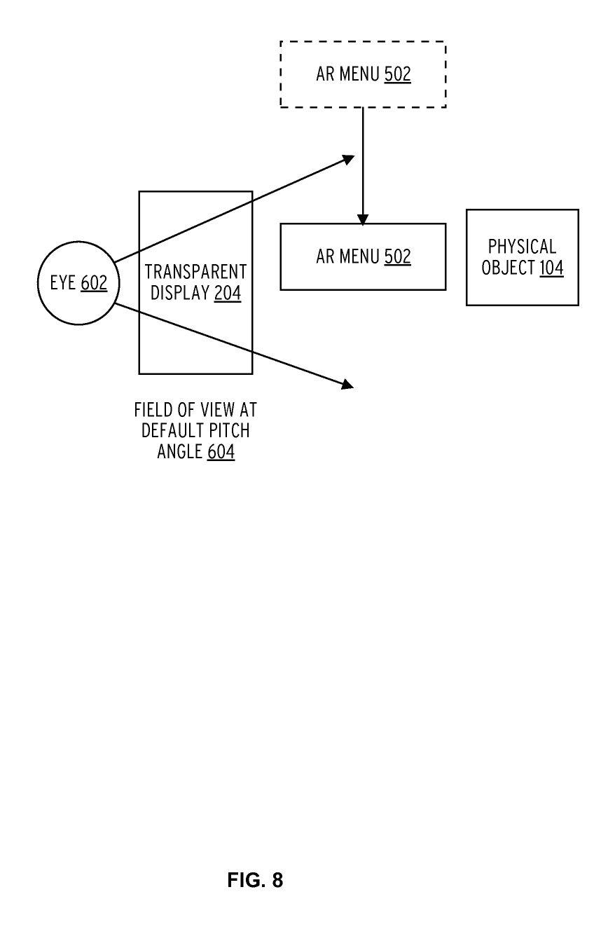

FIG. 8 is a block diagram illustrating a first example embodiment of an operation of an augmented reality user interface displayed in a head-mounted device at a reference pitch angle.

The AR menu 502 disappears from its perceived original position to appear within the field of view at reference pitch angle 604. In another example embodiment, the AR menu 502 appears to move to a horizontal level and appears in front of the physical object 104.

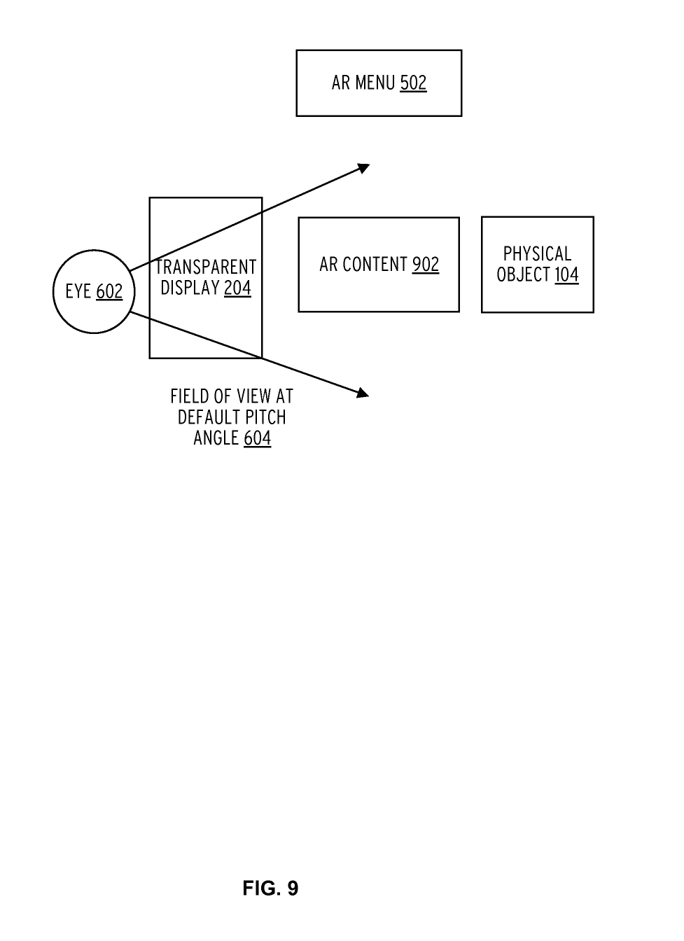

FIG. 9 is a block diagram illustrating a second example embodiment of an operation of an augmented reality user interface displayed in a head-mounted device at a reference pitch angle.

The transparent display 204 is positioned between the eye 602 of the user 106 and the physical object 104. The transparent display 204 displays AR content 902 in front of the physical object 104 within the field of view at reference pitch angle 604. The AR menu 502 is positioned outside the field of view at reference pitch angle 604. Therefore, the user 106 cannot see the AR menu 502 when looking straight at both the AR content 902 and the physical object 104. The user 106 would have to look up to see to the AR menu 502.

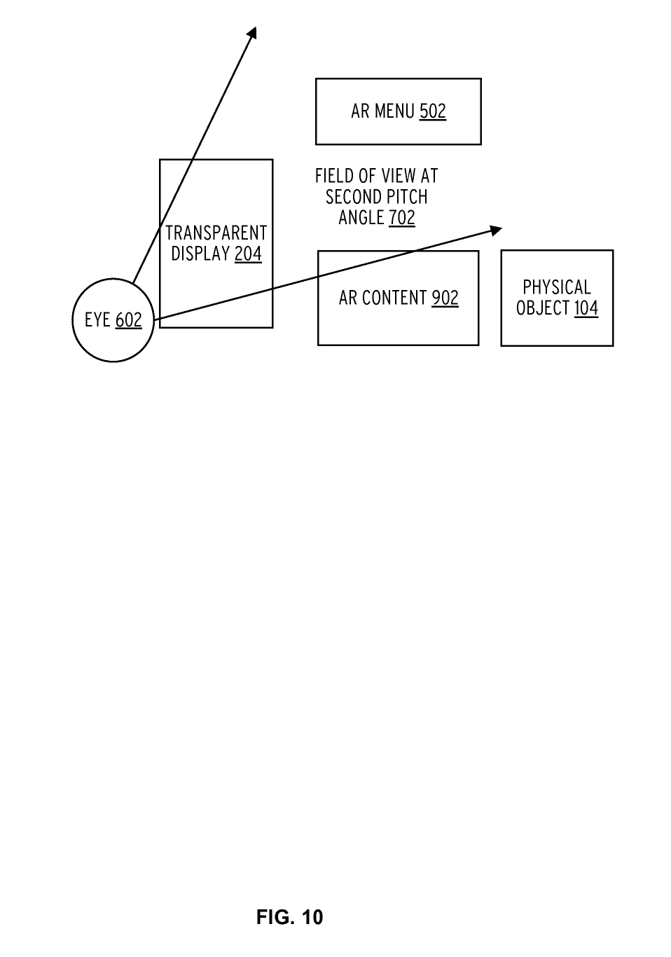

FIG. 10 is a block diagram illustrating a second example embodiment of an operation of an augmented reality user interface displayed in a head-mounted device at a second pitch angle.

When the user 106 looks up, the pitch angle of the head-mounted device 102 increases to a second pitch angle. The AR menu 502 is displayed in the transparent display 204 within a field of view at second pitch angle 702. In one example embodiment, the user 106 perceives the AR menu 502 as hovering above the head of the user 106. The AR content 902 may still be present when the user 106 looks down.

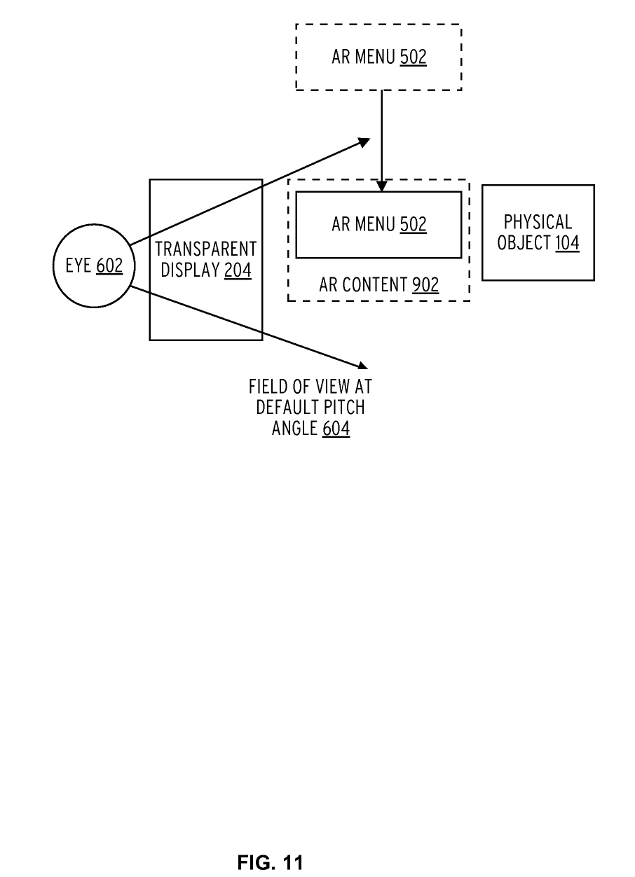

FIG. 11 is a block diagram illustrating a second example embodiment of an operation of an augmented reality user interface displayed in a head-mounted device at a reference pitch angle.

The AR menu 502 disappears from its perceived original position within the field of view at second pitch angle 702 and now appears within the field of view at reference pitch angle 604. In one example embodiment, the AR content 902 is no longer displayed in the transparent display 204 and is replaced with the AR menu 502. In another example embodiment, the AR menu 502 is displayed in front of the physical object 104.

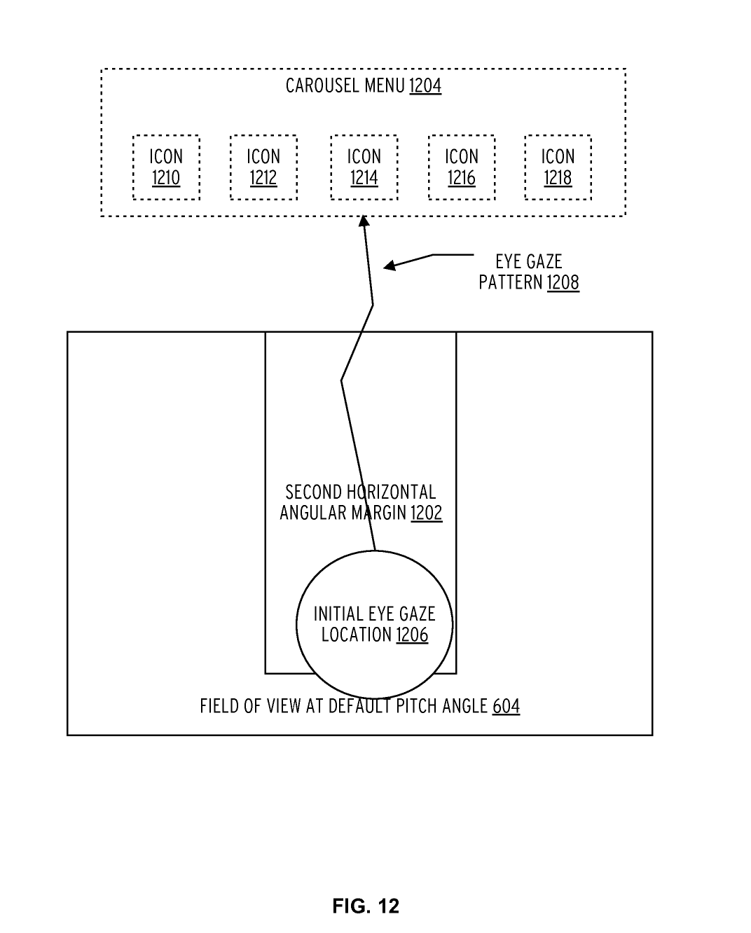

FIG. 12 is a block diagram illustrating an example embodiment of a horizontal angular margin for an eye gaze pattern of a head-mounted device at a reference pitch angle.

The AR user interface may include a carousel menu 1204 displaying several icons 1210, 1212, 1214, 1216, and 1218 outside a field of view at reference pitch angle 604. An initial eye gaze location 1206 is tracked to be within the field of view at reference pitch angle 604. Since there is no AR content displayed in the transparent display 204, the sweetspot region is relatively large compared to the field of view at reference pitch angle 604. The sweetspot region may be represented by the second horizontal angular margin 1202. The eye gaze of the user 106 is monitored, and the eye gaze pattern 1208 is determined to be within the second horizontal angular margin 1202.

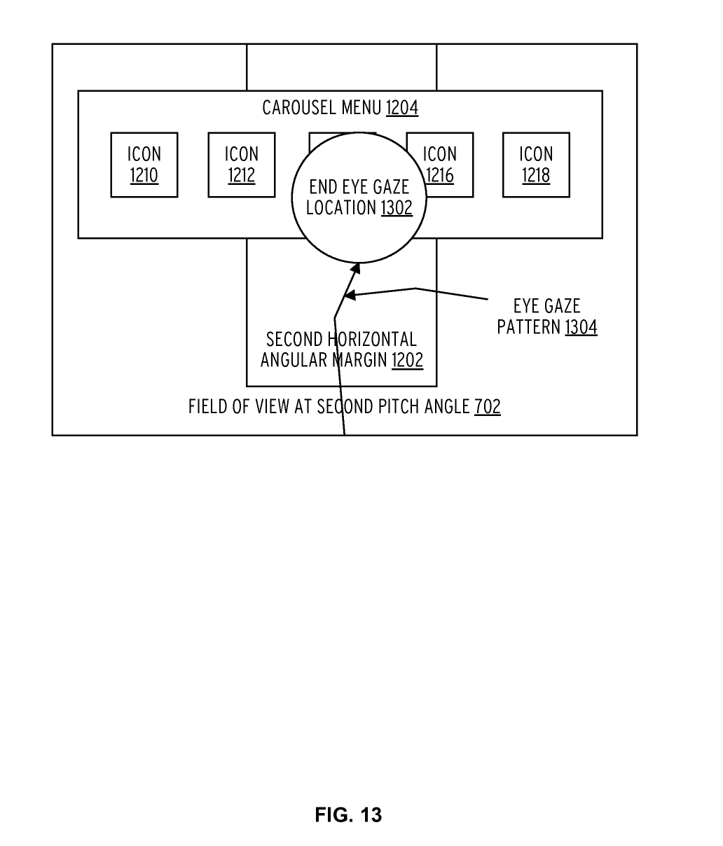

FIG. 13 is a block diagram illustrating an example embodiment of a horizontal angular margin for an eye gaze pattern of a head-mounted device at a second pitch angle.

An end eye gaze location 1302 is tracked to be within the field of view at second pitch angle 702. The eye gaze 1302 of the user is on icon 1214. An eye gaze pattern 1304 shows that the eye movements of the user 106 are still confined to within the second horizontal angular margin 1202.

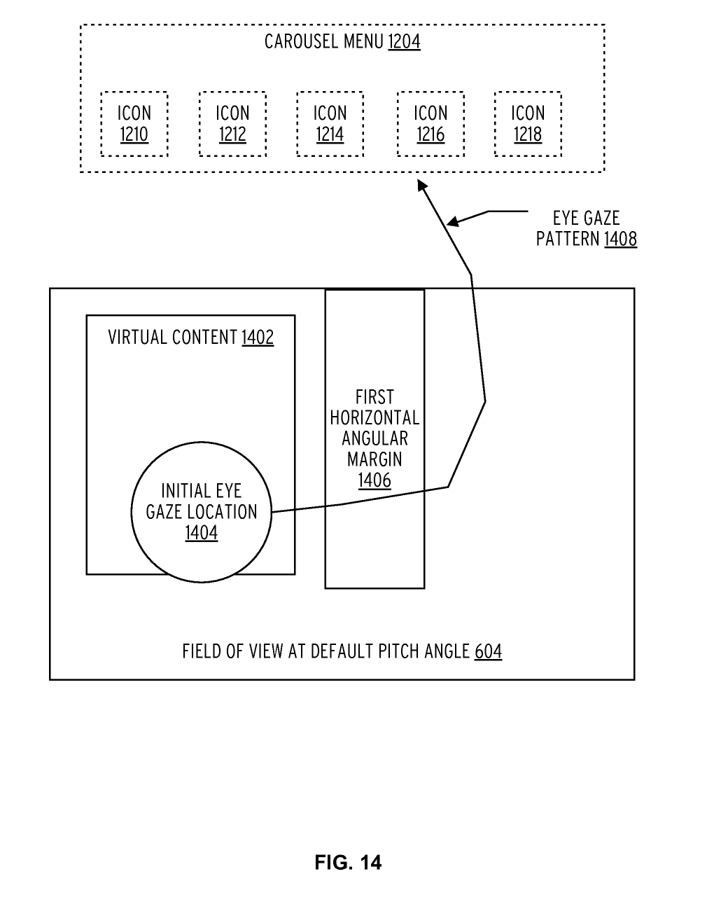

FIG. 14 is a block diagram illustrating an example embodiment of a horizontal angular margin for an eye gaze pattern of a head-mounted device at a second pitch angle.

The AR user interface may include a carousel menu 1204 displaying several icons 1210, 1212, 1214, 1216, and 1218 outside a field of view at reference pitch angle 604. An initial eye gaze location 1404 is tracked to be within the field of view at reference pitch angle 604. Since there is AR content (virtual content 1402) already displayed in the transparent display 204, the sweetspot region is relatively narrow compared to the field of view at reference pitch angle 604. The sweetspot region may be represented by the first horizontal angular margin 1406. The eye gaze of the user 106 is monitored and the eye gaze pattern 1408 is determined to be outside the first horizontal angular margin 1406.

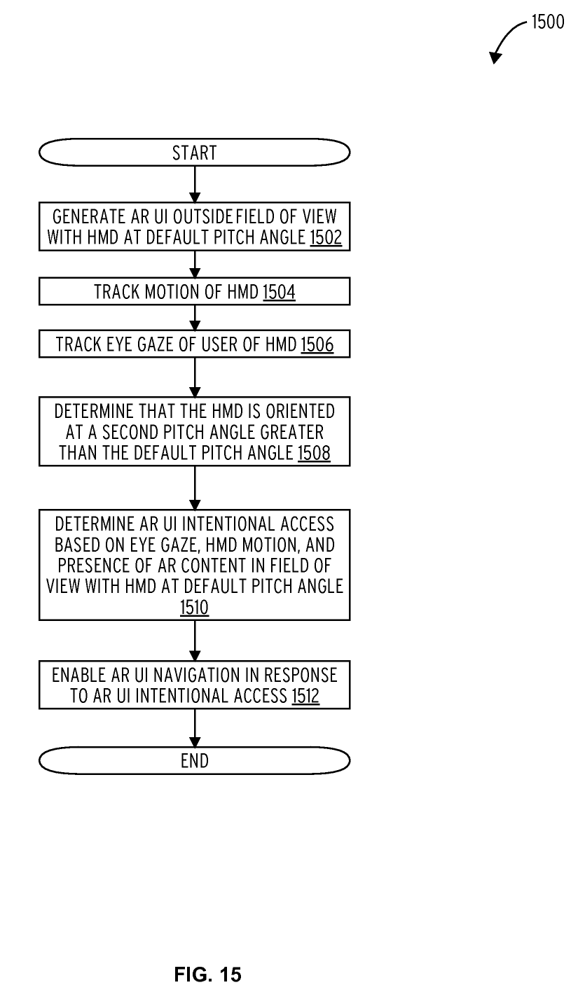

FIG. 15 is a flowchart illustrating an example operation 1500 of enabling an augmented reality user interface.

At block 1502 of operation 1500, an augmented reality user interface is generated outside a field of view of a user at a reference pitch angle of the head-mounted device 102. In one example embodiment, the user interface display module 308 generates the augmented reality user interface. At block 1504, a motion of the head-mounted device 102 is tracked. At block 1506, an eye gaze of the user 106 is tracked. In one example embodiment, blocks 1504 and 1506 may be implemented using the sensors 202, external sensors 112, the eye gaze module 302, and the HMD orientation module 304.

At block 1508, the HMD orientation module 304 determines that the head-mounted device 102 is oriented at a second pitch angle greater than the reference pitch angle (e.g., the head-mounted device 102 is pointed up).

At block 1510, the user interface display module 308 determines whether the user 106 intentionally seeks access to the AR user interface based on the eye gaze of the user 106, the motion of the head-mounted device 102, and the presence of AR content displayed in the transparent display 204 while the head-mounted device 102 is positioned at a reference pitch angle.

At block 1512, the user interface display module 308 enables the AR user interface if the user interface display module 308 determines that the user 106 intentionally seeks to engage the AR user interface.

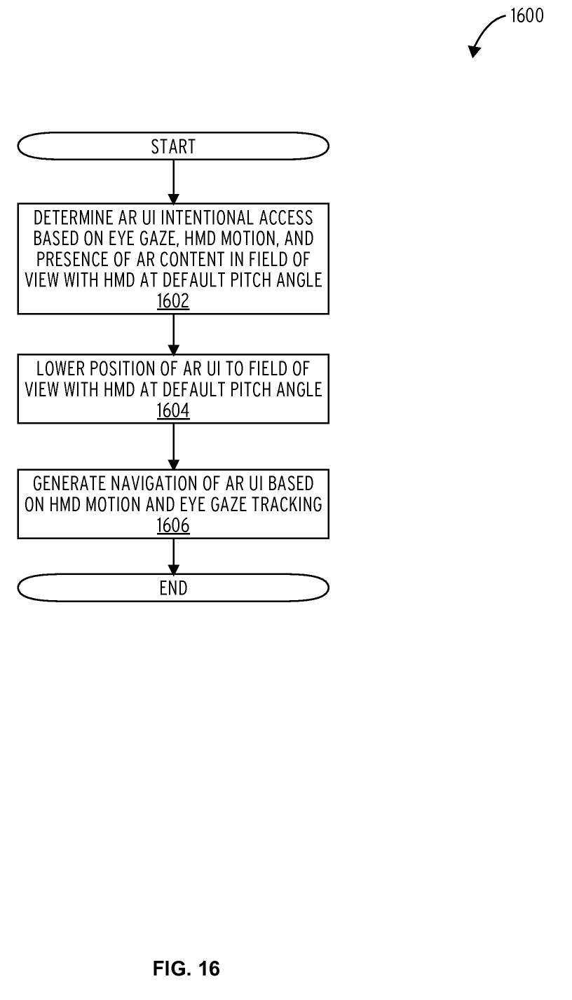

FIG. 16 is a flowchart illustrating an example operation 1600 of using an augmented reality user interface.

At block 1602 of operation 1600, the user interface display module 308 determines whether the user 106 intentionally seeks access to the AR user interface based on the eye gaze of the user 106, the motion of the head-mounted device 102, and the presence of AR content displayed in the transparent display 204 while the head-mounted device 102 is positioned at a reference pitch angle.

At block 1604, the user interface display module 308 lowers the display position of the AR user interface to be displayed within the field of view at reference pitch angle 604.

At block 1606, the user interface display module 308 generates navigation of the AR user interface based on the motion of the head-mounted device 102 and eye gaze movement.

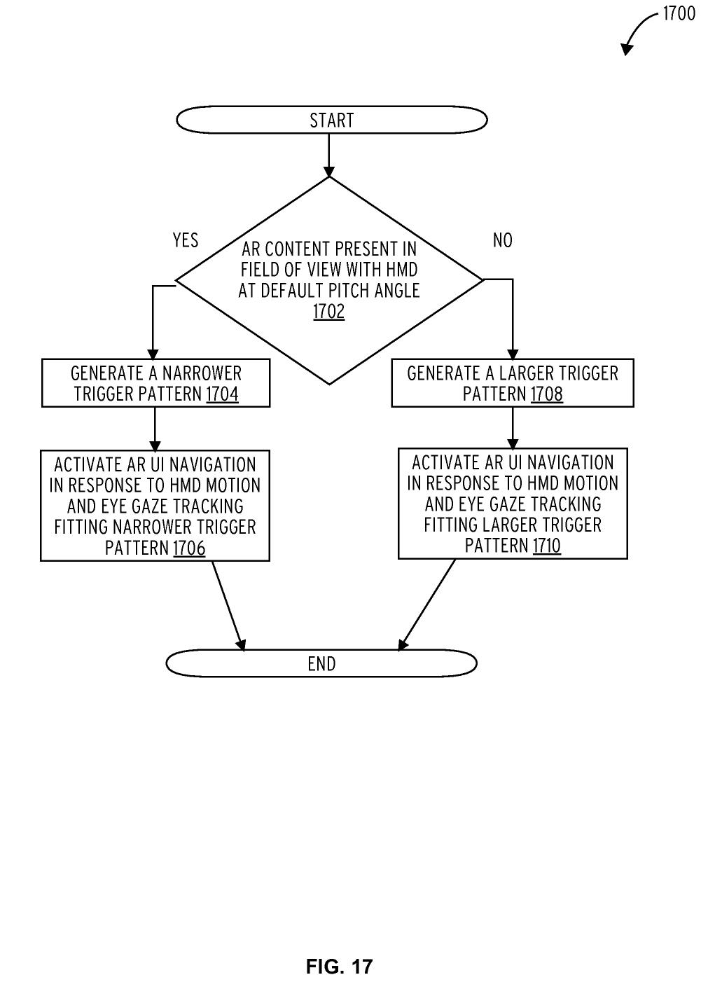

FIG. 17 is a flowchart illustrating an example of operation 1700 of activating an augmented reality user interface.

At decision block 1702 of operation 1700, the user interface display module 308 detects whether AR content is displayed within the field of view at reference pitch angle 604 of the head-mounted device 102. If AR content is already present, the user interface display module 308 generates a narrower user interface trigger pattern at block 1704. The user interface display module 308 activates engagement of the AR user interface in response to the motion of the head-mounted device 102, and eye gaze tracking locations fitting the narrower user interface trigger pattern at block 1706.

If AR content is not already present in the field of view at reference pitch angle 604, the user interface display module 308 generates a larger user interface trigger pattern at block 1708. The user interface display module 308 activates engagement of the AR user interface in response to the motion of the head-mounted device 102, and eye gaze tracking locations fitting the larger user interface trigger pattern at block 1710.

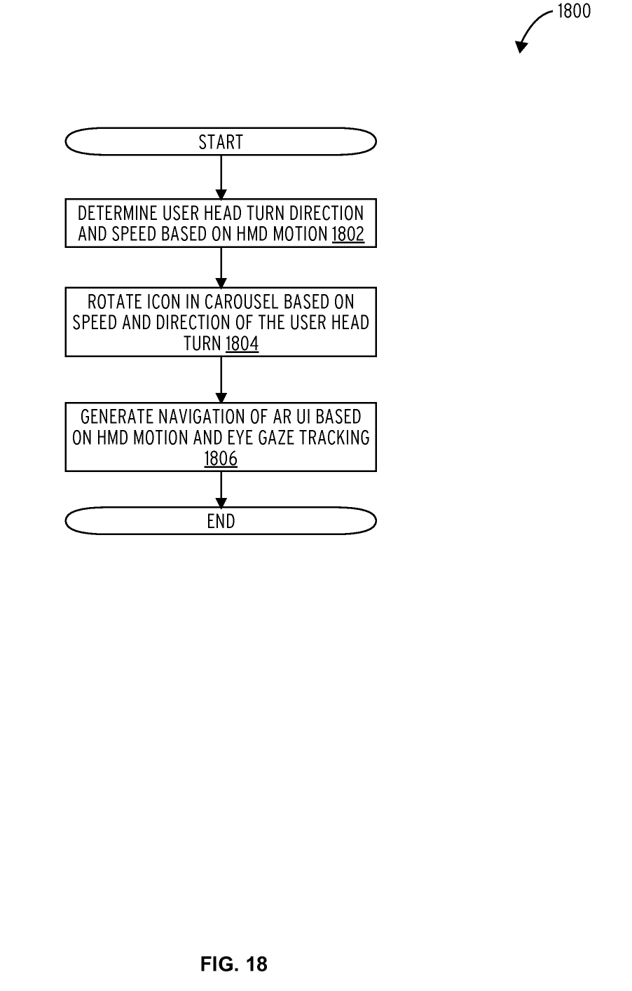

FIG. 18 is a flowchart illustrating an example operation 1800 of navigating an augmented reality user interface.

At block 1802 of operation 1800, the speed and direction in which the user 106 turns his/her head is determined. In one example embodiment, block 1802 may be implemented with the HMD orientation module 304.

At block 1804, the navigation module 310 rotates the carousel menu 1204 based on the speed and direction in which the user 106 turns his/her head. In one example embodiment, block 1802 may be implemented with the HMD orientation module 304.

At block 1806, the user 106 may navigate the AR user interface based on the speed and direction in which the user 106 turns his/her head and the eye gaze of the user 106.

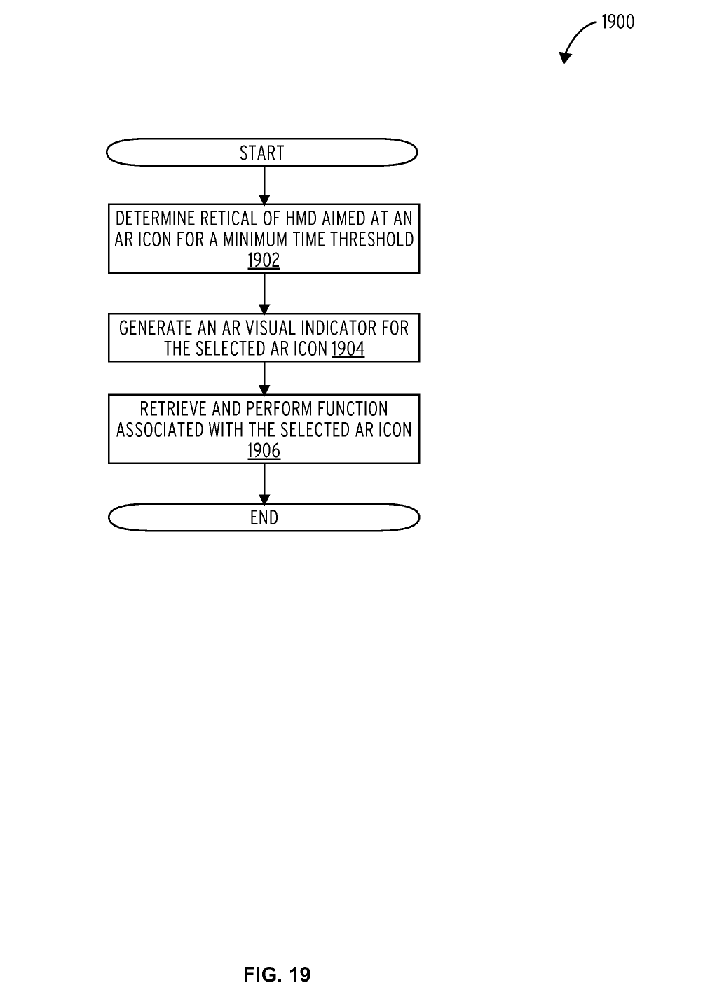

FIG. 19 is a flowchart illustrating an example operation 1900 of selecting an icon of an augmented reality user interface.

At block 1902 of operation 1900, a reticle (e.g., a static visual mark such as a cross-hair in the transparent display) of a head-mounted device 102 may be used to determine more accurately what the user 106 is looking at. For example, the user 106 may point the reticle of the head-mounted device 102 towards one of the icons (e.g., 1210-1218) in the carousel menu 1204 for a minimum time threshold.

At block 1904, the appearance of the selected icon may change (e.g., color or shape) in response to determining that the user 106 has pointed the reticle on the icon for longer than the minimum time threshold.

At block 1906, the AR user interface module 214 retrieves a function or an operation associated with the selected icon and performs the function.

FIG. 20 is a block diagram illustrating components of a machine 2000, according to some example embodiments, able to read instructions 2006 from a computer-readable medium 2018 (e.g., a non-transitory machine-readable medium, a machine-readable storage medium, a computer-readable storage medium, or any suitable combination thereof) and perform any one or more of the methodologies discussed herein, in whole or in part. Specifically, the machine 2000 is in the example form of a computer system (e.g., a computer) within which the instructions 2006 (e.g., software, a program, an application, an applet, an app, or other executable code) for causing the machine 2000 to perform any one or more of the methodologies discussed herein may be executed, in whole or in part.

In alternative embodiments, the machine 2000 operates as a standalone device or may be communicatively coupled (e.g., networked) to other machines. In a networked deployment, the machine 2000 may operate in the capacity of a server machine or a client machine in a server-client network environment, or as a peer machine in a distributed (e.g., peer-to-peer) network environment. The machine 2000 may be a server computer, a client computer, a personal computer (PC), a tablet computer, a laptop computer, a netbook, a cellular telephone, a smartphone, a set-top box (STB), a personal digital assistant (PDA), a web appliance, a network router, a network switch, a network bridge, or any machine capable of executing the instructions 2006, sequentially or otherwise, that specify actions to be taken by that machine. Further, while only a single machine is illustrated, the term “machine” shall also be taken to include any collection of machines that individually or jointly execute the instructions 2006 to perform all or part of any one or more of the methodologies discussed herein.

The machine 2000 includes a processor 2004 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 2010, and a static memory 2022, which are configured to communicate with each other via a bus 2012. The processor 2004 contains solid-state digital microcircuits (e.g., electronic, optical, or both) that are configurable, temporarily or permanently, by some or all of the instructions 2006 such that the processor 2004 is configurable to perform any one or more of the methodologies described herein, in whole or in part. For example, a set of one or more microcircuits of the processor 2004 may be configurable to execute one or more modules (e.g., software modules) described herein. In some example embodiments, the processor 2004 is a multicore CPU (e.g., a dual-core CPU, a quad-core CPU, or a 128-core CPU) within which each of multiple cores behaves as a separate processor that is able to perform any one or more of the methodologies discussed herein, in whole or in part. Although the beneficial effects described herein may be provided by the machine 2000 with at least the processor 2004, these same beneficial effects may be provided by a different kind of machine that contains no processors (e.g., a purely mechanical system, a purely hydraulic system, or a hybrid mechanical-hydraulic system), if such a processor-less machine is configured to perform one or more of the methodologies described herein.

The machine 2000 may further include a video display 2008 (e.g., a plasma display panel (PDP), a light emitting diode (LED) display, a liquid crystal display (LCD), a projector, a cathode ray tube (CRT), or any other display capable of displaying graphics or video). The machine 2000 may also include an alpha-numeric input device 2014 (e.g., a keyboard or keypad), a cursor control device 2016 (e.g., a mouse, a touchpad, a trackball, a joystick, a motion sensor, an eye tracking device, or other pointing instrument), a drive unit 2002, a signal generation device 2020 (e.g., a sound card, an amplifier, a speaker, a headphone jack, or any suitable combination thereof), and a network interface device 2024.

The drive unit 2002 (e.g., a data storage device) includes the computer-readable medium 2018 (e.g., a tangible and non-transitory machine-readable storage medium) on which are stored the instructions 2006 embodying any one or more of the methodologies or functions described herein. The instructions 2006 may also reside, completely or at least partially, within the main memory 2010, within the processor 2004 (e.g., within the processor's cache memory), or both, before or during execution thereof by the machine 2000. Accordingly, the main memory 2010 and the processor 2004 may be considered machine-readable media (e.g., tangible and non-transitory machine-readable media). The instructions 2006 may be transmitted or received over a computer network via the network interface device 2024. For example, the network interface device 2024 may communicate the instructions 2006 using any one or more transfer protocols (e.g., hypertext transfer protocol (HTTP)).

In some example embodiments, the machine 2000 may be a portable computing device (e.g., a smart phone, tablet computer, or a wearable device), and have one or more additional input components (e.g., sensors or gauges). Examples of such input components include an image input component (e.g., one or more cameras), an audio input component (e.g., one or more microphones), a direction input component (e.g., a compass), a location input component (e.g., a global positioning system (GPS) receiver), an orientation component (e.g., a gyroscope), a motion detection component (e.g., one or more accelerometers), an altitude detection component (e.g., an altimeter), a biometric input component (e.g., a heart rate detector or a blood pressure detector), and a gas detection component (e.g., a gas sensor). Input data gathered by any one or more of these input components may be accessible and available for use by any of the modules described herein.

As used herein, the term “memory” refers to a machine-readable medium able to store data temporarily or permanently and may be taken to include, but not be limited to, random-access memory (RAM), read-only memory (ROM), buffer memory, flash memory, and cache memory. While the computer-readable medium 2018 is shown in an example embodiment to be a single medium, the term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing the instructions 2006 for execution by the machine 2000, such that the instructions 2006, when executed by one or more processors of the machine 2000 (e.g., processor 2004), cause the machine 2000 to perform any one or more of the methodologies described herein, in whole or in part. Accordingly, a “machine-readable medium” refers to a single storage apparatus or device, as well as cloud-based storage systems or storage networks that include multiple storage apparatus or devices. The term “machine-readable medium” shall accordingly be taken to include, but not be limited to, one or more tangible and non-transitory data repositories (e.g., data volumes) in the example form of a solid-state memory chip, an optical disc, a magnetic disc, or any suitable combination thereof. A “non-transitory” machine-readable medium, as used herein, specifically does not include propagating signals per se. In some example embodiments, the instructions 2006 for execution by the machine 2000 may be communicated by a carrier medium. Examples of such a carrier medium include a storage medium (e.g., a non-transitory machine-readable storage medium, such as a solid-state memory, being physically moved from one place to another place) and a transient medium (e.g., a propagating signal that communicates the instructions 2006).

Certain example embodiments are described herein as including modules. Modules may constitute software modules (e.g., code stored or otherwise embodied in a machine-readable medium or in a transmission medium), hardware modules, or any suitable combination thereof. A “hardware module” is a tangible (e.g., non-transitory) physical component (e.g., a set of one or more processors) capable of performing certain operations and may be configured or arranged in a certain physical manner. In various example embodiments, one or more computer systems or one or more hardware modules thereof may be configured by software (e.g., an application or portion thereof) as a hardware module that operates to perform operations described herein for that module.

In some example embodiments, a hardware module may be implemented mechanically, electronically, hydraulically, or any suitable combination thereof. For example, a hardware module may include dedicated circuitry or logic that is permanently configured to perform certain operations. A hardware module may be or include a special-purpose processor, such as a field programmable gate array (FPGA) or an ASIC. A hardware module may also include programmable logic or circuitry that is temporarily configured by software to perform certain operations. As an example, a hardware module may include software encompassed within a CPU or other programmable processor. It will be appreciated that the decision to implement a hardware module mechanically, hydraulically, in dedicated and permanently configured circuitry, or in temporarily configured circuitry (e.g., configured by software) may be driven by cost and time considerations.

Accordingly, the phrase “hardware module” should be understood to encompass a tangible entity that may be physically constructed, permanently configured (e.g., hardwired), or temporarily configured (e.g., programmed) to operate in a certain manner or to perform certain operations described herein. Furthermore, as used herein, the phrase “hardware-implemented module” refers to a hardware module. Considering example embodiments in which hardware modules are temporarily configured (e.g., programmed), each of the hardware modules need not be configured or instantiated at any one instance in time. For example, where a hardware module includes a CPU configured by software to become a special-purpose processor, the CPU may be configured as respectively different special-purpose processors (e.g., each included in a different hardware module) at different times. Software (e.g., a software module) may accordingly configure one or more processors, for example, to become or otherwise constitute a particular hardware module at one instance of time and to become or otherwise constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over suitable circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory (e.g., a memory device) to which it is communicatively coupled. A further hardware module may then, at a later time, access the memory to retrieve and process the stored output. Hardware modules may also initiate communications with input or output devices, and can operate on a resource (e.g., a collection of information from a computing resource).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module in which the hardware includes one or more processors. Accordingly, the operations described herein may be at least partially processor-implemented, hardware-implemented, or both, since a processor is an example of hardware, and at least some operations within any one or more of the methods discussed herein may be performed by one or more processor-implemented modules, hardware-implemented modules, or any suitable combination thereof.

Moreover, such one or more processors may perform operations in a “cloud computing” environment or as a service (e.g., within a “software as a service” (SaaS) implementation). For example, at least some operations within any one or more of the methods discussed herein may be performed by a group of computers (e.g., as examples of machines that include processors), with these operations being accessible via a network (e.g., the Internet) and via one or more appropriate interfaces (e.g., an application program interface (API)). The performance of certain operations may be distributed among the one or more processors, whether residing only within a single machine or deployed across a number of machines. In some example embodiments, the one or more processors or hardware modules (e.g., processor-implemented modules) may be located in a single geographic location (e.g., within a home environment, an office environment, or a server farm). In other example embodiments, the one or more processors or hardware modules may be distributed across a number of geographic locations.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and their functionality presented as separate components and functions in example configurations may be implemented as a combined structure or component with combined functions. Similarly, structures and functionality presented as a single component may be implemented as separate components and functions. These and other variations, modifications, additions, and improvements fall within the scope of the subject matter herein.

Some portions of the subject matter discussed herein may be presented in terms of algorithms or symbolic representations of operations on data stored as bits or binary digital signals within a memory (e.g., a computer memory or other machine memory). Such algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “accessing,” “processing,” “detecting,” “computing,” “calculating,” “determining,” “generating,” “presenting,” “displaying,” or the like refer to actions or processes performable by a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

The following embodiments describe various example embodiments of methods, machine-readable media, and systems (e.g., machines, devices, or other apparatus) discussed herein.

In some embodiments, a head-mounted device (HMD) may include a sensors, a transparent display, and/or a processor.

In some embodiments, the processor may include an augmented reality (AR) application and an AR user interface module, the AR application configured to generate a virtual content based on data from the sensors, and to display the virtual content in the transparent display.

In some embodiments, the AR user interface module, configured to generate an AR user interface that is positioned outside a field of view of a user based on the HMD, may be oriented at a reference pitch angle, to cause a display of the AR user interface in the transparent display within the field of view of the user based on the HMD.

In some embodiments, the AR user interface module configured to generate an AR user interface that is positioned outside a field of view of a user based on the HMD may be oriented at a second pitch angle greater than the reference pitch angle, and to cause a navigation of the AR user interface in response to a motion of the HMD and an eye gaze of the user matching a user interface trigger pattern.

In some embodiments, the user interface trigger pattern may include a first horizontal angular margin and a second horizontal angular margin, the first horizontal angular margin based on the presence of the virtual content displayed in the transparent display of the HMD oriented at the reference pitch angle, the second set of patterns based on the absence of any virtual content displayed in the transparent display of the HMD oriented at the reference pitch angle.

In some embodiments, the second horizontal angular margin may be greater than the first horizontal angular margin.

In some embodiments, the AR user interface module causes the display of the AR user interface (in the transparent display within the field of view of the user based on the HMD may be oriented) at a pitch angle in response to a trajectory of the motion of the HMD and the eye gaze of the user.

In some embodiments, the AR user interface module causes the display of the AR user interface (in the transparent display within the field of view of the user) based on the HMD may be within the first horizontal angular margin and second horizontal angular margin.

In some embodiments, the AR user interface module may include an eye gaze module configured to track an eye gaze of the user of the HMD, a HMD orientation module configured to track the motion of the HMD, an AR content module configured to detect the presence of the virtual content displayed in the transparent display of the HMD oriented at the reference pitch angle, and/or a user interface display module configured to generate the user interface trigger pattern based on the presence of the virtual content displayed in the transparent display of the HMD oriented at the reference pitch angle.

In some embodiments, the user interface display module may include a navigation module and an icon selection module, the navigation module configured to navigate through the user interface based on a direction and speed of the motion of the HMD, the icon selection module configure to select an icon from the user interface based on a persistence of an eye gaze towards the icon displayed in the transparent display for a minimum time threshold.

In some embodiments, the AR user interface module is configured to cause a display of the AR user interface in the transparent display within the field of view of the user based on the HMD being oriented at the reference pitch angle in response to the motion of the HMD and the eye gaze of the user matching the user interface trigger pattern.

In some embodiments, the user interface trigger pattern may include a maximum duration between the eye gaze of the user at the reference pitch angle and the eye gaze of the user at the second pitch angle, and a minimum duration of the eye gaze at the second pitch angle.

In some embodiments, the AR user interface may include a virtual carousel with a group of icons around the user.

In some embodiments, a direction and speed of rotation of the virtual carousel relative to the user is based on a direction and speed of the motion of the HMD.

In some embodiments, the sensor may include an inertial measurement unit and an eye gaze tracking sensor.

1-10. (canceled)

11. A computer-implemented method comprising:
generating, by a head-mounted device (HMD), an augmented reality (AR) user interface that is positioned outside a field of view of a user of a head-mounted device (HMD) based on the HMD being oriented at a reference pitch angle, the AR user interface associated with a first threshold angular margin for causing presentation of the AR user interface when AR content is presented on a display of the HMD, and a second threshold angular margin for causing presentation of the AR user interface when AR content is not presented on the display of the HMD, the first threshold angular margin being greater than the second threshold angular margin;
while AR content is not being presented on the display of the HMD, detecting that orientation of the HMD has changed to a first adjusted pitch angle;
comparing the first adjusted pitch angle to the second threshold angular margin for causing presentation of the AR user interface when AR content is not presented on the display of the HMD; and
in response to determining that the first adjusted pitch angle is greater than the second threshold angular margin, causing presentation of the AR user interface on the display of the HMD within the field of view of the user, the first adjusted pitch angle being less than the first threshold angular margin for causing presentation of the AR user interface when AR content is presented on the display of the HMD.

12. (canceled)

13. (canceled)

14. The computer-implemented method of claim 11,
wherein detecting that orientation of the HMD has changed comprises:
tracking, using one or more optical sensors of the HMD, an eye gaze of the user of the HMD; and
tracking, using one or more motion sensors of the HMD, motion of the HMD.

15. The computer-implemented method of claim 11, further comprising:
after causing presentation of the AR user interface, causing navigating through the AR user interface based on a detected direction and speed of motion of the HMD;
determining that an eye gaze of the user towards an icon displayed in the AR user interface exceeds a minimum time threshold; and
causing selection of the icon from the AR user interface based on the eye gaze of the user exceeding the minimum time threshold.

16. The computer-implemented method of claim 11, further comprising:
while AR content is being presented on the display of the HMD, detecting that orientation of the HMD has changed to a second adjusted pitch angle;
comparing the second adjusted pitch angle to the first threshold angular margin for causing presentation of the AR user interface when AR content is being presented on the display of the HMD; and
in response to determining that the second adjusted pitch angle is greater than the first threshold angular margin, causing presentation of the AR user interface on the display of the HMD within the field of view of the user based.

17. The computer-implemented method of claim 11, wherein, detecting that orientation of the HMD has changed to the first adjusted pitch angle comprises:
determining that orientation of the HMD has been sustained for a minimum threshold duration.

18. The computer-implemented method of claim 11, wherein the AR user interface includes a virtual carousel with a plurality of icons around the user.

19. The computer-implemented method of claim 18, wherein a direction and speed of rotation of the virtual carousel relative to the user are based on a direction and speed of motion of the HMD.

20. A non-transitory machine-readable medium comprising instructions that, when executed by one or more processors of a head-mounted device (HMD), cause the HMD to perform operations comprising:
generating an augmented reality (AR) user interface that is positioned outside a field of view of a user of the HMD based on the HMD being oriented at a reference pitch angle, the AR user interface associated with a first threshold angular margin for causing presentation of the AR user interface when AR content is presented on a display of the HMD, and a second threshold angular margin for causing presentation of the AR user interface when AR content is not presented on the display of the HMD, the first threshold angular margin being greater than the second threshold angular margin;
while AR content is not being presented on the display of the HMD, detecting that orientation of the HMD has changed to a first adjusted pitch angle;
comparing the first adjusted pitch angle to the second threshold angular margin for causing presentation of the AR user interface when AR content is not presented on the display of the HMD; and
in response to determining that the first adjusted pitch angle is greater than the second threshold angular margin, causing presentation of the AR user interface on the display of the HMD within the field of view of the user, the first adjusted pitch angle being less than the first threshold angular margin for causing presentation of the AR user interface when AR content is presented on the display of the HMD.

21. The non-transitory machine-readable medium of claim 20, wherein detecting that orientation of the HMD has changed comprises:
tracking, using one or more optical sensors of the HMD, an eye gaze of the user of the HMD; and
tracking, using one or more motion sensors of the HMD, motion of the HMD.

22. The non-transitory machine-readable medium of claim 20, the operations further comprising:
after causing presentation of the AR user interface, causing navigating through the AR user interface based on a detected direction and speed of motion of the HMD;
determining that an eye gaze of the user towards an icon displayed in the AR user interface exceeds a minimum time threshold; and
causing selection of the icon from the AR user interface based on the eye gaze of the user exceeding the minimum time threshold.

23. The non-transitory machine-readable medium of claim 20, the operations further comprising:
while AR content is being presented on the display of the HMD, detecting that orientation of the HMD has changed to a second adjusted pitch angle;
comparing the second adjusted pitch angle to the first threshold angular margin for causing presentation of the AR user interface when AR content is being presented on the display of the HMD; and
in response to determining that the second adjusted pitch angle is greater than the first threshold angular margin, causing presentation of the AR user interface on the display of the HMD within the field of view of the user based.

24. The non-transitory machine-readable medium of claim 20, wherein, detecting that orientation of the HMD has changed to the first adjusted pitch angle comprises:
determining that orientation of the HMD has been sustained for a minimum threshold duration.

25. The non-transitory machine-readable medium of claim 20, wherein the AR user interface includes a virtual carousel with a plurality of icons around the user.

26. The non-transitory machine-readable medium of claim 25, wherein a direction and speed of rotation of the virtual carousel relative to the user are based on a direction and speed of motion of the HMD.

27. A method comprising:
generating, by a head mounted device (HMD) an augmented reality (AR) user interface that is positioned outside a field of view of a user of HMD based on the HMD being oriented at a reference pitch angle, the AR user interface associated with a first threshold angular margin for causing presentation of the AR user interface when AR content is presented on a display of the HMD, and a second threshold angular margin for causing presentation of the AR user interface when AR content is not presented on the display of the HMD, the first threshold angular margin being greater than the second threshold angular margin;
while AR content is not being presented on the display of the HMD, detecting that orientation of the HMD has changed to a first adjusted pitch angle;
comparing the first adjusted pitch angle to the second threshold angular margin for causing presentation of the AR user interface when AR content is not presented on the display of the HMD; and
in response to determining that the first adjusted pitch angle is greater than the second threshold angular margin, causing presentation of the AR user interface on the display of the HMD within the field of view of the user, the first adjusted pitch angle being less than the first threshold angular margin for causing presentation of the AR user interface when AR content is presented on the display of the HMD.

28. The method of claim 27, wherein detecting that orientation of the HMD has changed comprises:
tracking, using one or more optical sensors of the HMD, an eye gaze of the user of the HMD; and
tracking, using one or more motion sensors of the HMD, motion of the HMD.

29. The method of claim 27, further comprising:
after causing presentation of the AR user interface, causing navigating through the AR user interface based on a detected direction and speed of motion of the HMD;
determining that an eye gaze of the user towards an icon displayed in the AR user interface exceeds a minimum time threshold; and
causing selection of the icon from the AR user interface based on the eye gaze of the user exceeding the minimum time threshold.

30. The method of claim 27, further comprising:
while AR content is being presented on the display of the HMD, detecting that orientation of the HMD has changed to a second adjusted pitch angle;
comparing the second adjusted pitch angle to the first threshold angular margin for causing presentation of the AR user interface when AR content is being presented on the display of the HMD; and
in response to determining that the second adjusted pitch angle is greater than the first threshold angular margin, causing presentation of the AR user interface on the display of the HMD within the field of view of the user based.

31. The method of claim 27, wherein, detecting that orientation of the HMD has changed to the first adjusted pitch angle comprises:
determining that orientation of the HMD has been sustained for a minimum threshold duration.

32. The method of claim 27, wherein the AR user interface includes a virtual carousel with a plurality of icons around the user, a direction and speed of rotation of the virtual carousel relative to the user being based on a direction and speed of motion of the HMD.
